(19) United States
(12) Patent Application Publication
(10) Pub. No.: US 2002/0171415 A1
(43) Pub. Date: Nov. 21, 2002

(54) Device for measuring swing velocity of the golf club head using the resonance circuit

(76) Inventor: Ji-Joong Lim, Seoul (KR)

Correspondence Address: JOHN F. DOLAN, ESQ., FREDRIKSON & BYRON, P.A., 1100 INTERNATIONAL CENTER, 900 SECOND AVENUE SOUTH, MINNEAPOLIS, MN, 55402-3397, US

(21) Appl. No.: 10/070,190

(22) PCT Filed: Jun. 30, 2001
(86) PCT No.: PCT/KR01/01128

(30) Foreign Application Priority Data
Jul. 1, 2000 (KR) 2000/37591

(51) Int. Cl. G01P 3/42; G01P 3/48; G01P 3/54

(52) U.S. Cl. 324/176; 324/160; 324/173

(57) ABSTRACT

The present invention relates to a device for measuring swing velocity of a golf club head sing a resonance circuit. The device according to the present invention comprises a resonance circuit portion for detecting impedance change amount and voltage signal by the amount of impedance change in response to the approach of a golf club head having conductivity; an amplification portion for amplifying the voltage signal detected by the resonance circuit portion, a wave shaping portion for outputting the voltage signal as pulse-shaped peak wave; a mircocomputer for controlling the operation of calculating the time difference between the peak waves and indicating swing velocity; and a display portion for displaying the swing velocity data according to the output signal of the microcomputer. The device according to the present invention allows the user to swing at regular and stable maximum speed by displaying the swing velocity at the impact moment that the golf club head heats the ball on predetermined displaying devices.

### BACKGROUND OF THE INVENTION

(a) Field of the Invention

The present invention relates to a device for measuring swing velocity of a golf club head, and more particularly, to a device for measuring swing velocity of a golf club head by detecting voltage signal in response to change of impedance when the golf club swung by a user passes by a resonance circuit spaced by a predetermined distance, calculating the swing velocity of the golf club head, and displaying the swing velocity data for the user.

(b) Description of the Related Art

Recently, as a number of people who enjoy the golf increases, the golf is understood as a public sport.

Since a distance that a golf ball flies generally more increases the faster the golf club head speed at a moment of impact, that is, a moment when a golf club head heat a ball is, the golfer tries to increase the swing velocity of a golf club head. In addition, a current tendency of the golf sport is changing from technique-oriented to power-oriented. That is, a hit preference of golfers changes from accuracy first and distance second to distance first and accuracy second.

Generally, the golfer measures and monitors swing velocity of a golf club head to increase swing velocity of a golf club. For this, the following devices has conventionally been used: an analog device for measuring swing velocity of a golf club head by mounting a mechanical device using gears as described in Korean Utility Patent Laid-Open Publication No. 1998-9255; a device for measuring swing velocity of a golf club head by mounting a magnetized pad on a lower part of a golf club and allowing an electronic circuit to sense change of magnetic flux in response to the movement of the magnetized pad when the golf club is swung; and a device for measuring swing velocity comprising an electronic circuit using a receiver and a transmitter of infrared rays.

However, the analog device for measuring swing velocity among the conventional devices for measuring swing velocity of a golf club head has some defects that there is a difference in weight between a golf club for measuring swing velocity and one for practical use since the golf club for measuring swing velocity is mounted with a mechanical device, and there can not be obtained accurate data for the swing velocity of a golf club head since the swing velocity data is provided in analog.

Further, in case of the device for measuring swing velocity of a golf club head by sensing change of magnetic flux in response to the movement of the magnetized pad, since the magnetized pad should be mounted on the golf club head to measure swing velocity, it is troublesome to mount and demount the magnetized pad. And, when the swing velocity of a golf club is low, it is difficult to accurately measure swing velocity since a generated voltage using the magnetized pad is very low such that the ratio of signal to noise is not large enough to calculate accurate swing velocity.

Further, in case of the optical device for measuring swing velocity using an electronic circuit using a receiver and a transmitter of infrared rays, the infrared rays output from a transmitter should be input into a receiver after being reflected by a golf club head. However, when an angle of reflection is not proper, the infrared rays receiver cannot sense the reflected infrared rays on the surface of the golf club during the movement of the same. In such a case, the measurement for swing velocity of the golf club head is impossible.

### SUMMARY OF THE INVENTION

It is an object of the present invention is to overcome the above-mentioned problems of the conventional devices for measuring swing velocity of a golf club head, and to provide a device for measuring swing velocity of the same using a resonance circuit, characterized in that the measurement of swing velocity is performed in the same condition as that of the practically used golf club, the sensitivity and the ratio of signal to noise is high in comparison with those of the device for measuring swing velocity of a golf club head mounted with the magnetized pad, and the rate of misoperation is low in comparison with that of the optical device for measuring swing velocity of a golf club head.

To achieve the above object, the device for measuring swing velocity of a golf club head according to the present invention comprises a resonance circuit portion having a first parallel resonance circuit and a second parallel resonance circuit that are spaced from each other by a predetermined distance, a first voltage detector and a second voltage detector for detecting voltage signal by the amount of impedance change generated from each resonance circuit as the golf club head having conductivity becomes closer to the first and second parallel resonance circuits; and an oscillator applying predetermined frequency to the first and second parallel resonance circuits; an amplification portion for amplifying each voltage signal detected by the first and second voltage detectors; a wave shaping portion for outputting each voltage signal output from the amplification portion as pulse-shaped peak wave on the basis of predetermined comparative voltage value; a microcomputer for controlling the operation of calculating the time difference between the peak waves, and indicating swing velocity data of the golf club head using the difference of times that the peak waves are generated and the distance between the first parallel resonance circuit and the second parallel resonance circuit; and a display portion for displaying the swing velocity data according to the output signal of the microcomputer.

According to the device of the present invention, the display portion comprises a multiplicity of displaying devices. When the golfer swings 1˜N times, the Nth swing data is displayed in the first displaying device, and the data from the (N−1)th to the first swing are respectively displayed in the second displaying device to the Nth one in reverse order.

According to the device of the present invention, the displaying devices preferably display the average, the dispersion rate, the deviation and the standard deviation of swing velocity of a golf club head according to the control of the microcomputer.

The device for measuring swing velocity of the golf club head according to the present invention may further comprise a displaying device for displaying a flight distance of golf ball on the basis of the swing velocity of the golf club head according to the control of the microcomputer.

### BRIEF DESCRIPTION OF THE DRAWINGS

A more complete appreciation of the present invention, and many of the attendant advantages thereof, will be readily become better understood by referring to the following detailed description when considered in conjunction with the accompanying drawings, in which like reference symbols indicate the same or the similar components, wherein:

FIG. 1 is a rough block diagram of a device for measuring swing velocity of a golf club head using the resonance circuit according to the present invention;

FIG. 2 is a detailed block diagram of the device for measuring swing velocity of a golf club head using the resonance circuit according to the present invention;

FIG. 3 shows that a golf club head is being swung with using the device for measuring swing velocity of a golf club head according to the present invention;

FIG. 4 is a circuit diagram for showing operation process of a parallel resonance circuit when a golf club head is swung with using the device for measuring swing velocity of a golf club head according to the present invention;

FIG. 5 is a diagram of voltage waveform showing change of voltage detected by a first voltage detector and a second voltage detector in response to time, which are included in a device for measuring swing velocity of a golf club head according to the present invention;

FIG. 6 is a diagram of voltage waveform showing change of voltage output from a wave shaping portion in response to time, which is included in a device for measuring swing velocity of a golf club head according to the present invention;

FIG. 7 is a circuit diagram of an embodiment of a first and a second wave shaping devices, which are included in a device for measuring swing velocity of a golf club head according to the present invention; and

FIG. 8 is a diagram of voltage waveform showing a principle that the voltage signal is shaped in a wave shaping portion comprising a first and a second wave shaping devices, which are included in a device for measuring swing velocity of a golf club head according to the present invention, by showing both comparative voltage value for shaping voltage and amplified voltage signal input from a amplification portion.

### DETAILED DESCRIPTION OF THE PREFERRED EMBODIMENTS

The detailed description of the present invention referring to the experimental examples and embodiments is provided hereinafter. However, the embodiments according to the present invention can be modified in various ways and the claims of the present invention should not be understood to be restricted to the embodiments described below. The embodiments of the present invention are provided to more clearly and easily describe the present invention to a person who has standard knowledge in this technical area.

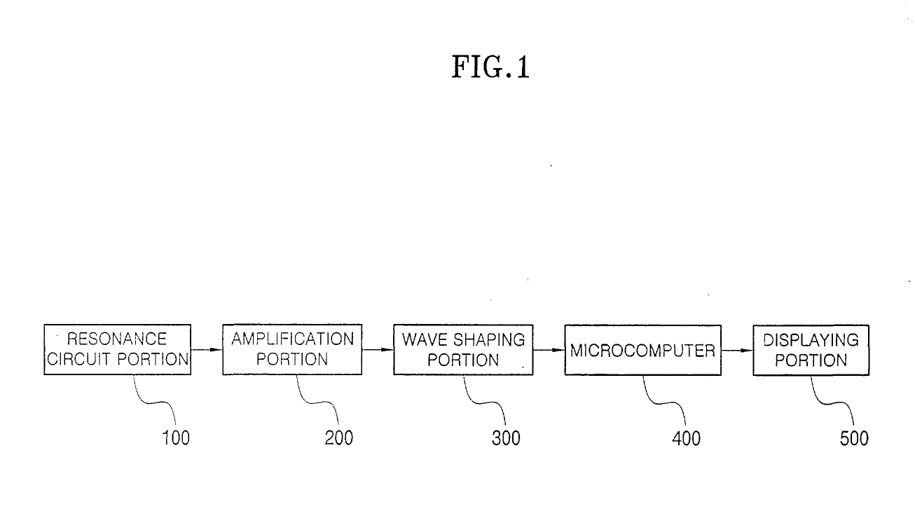

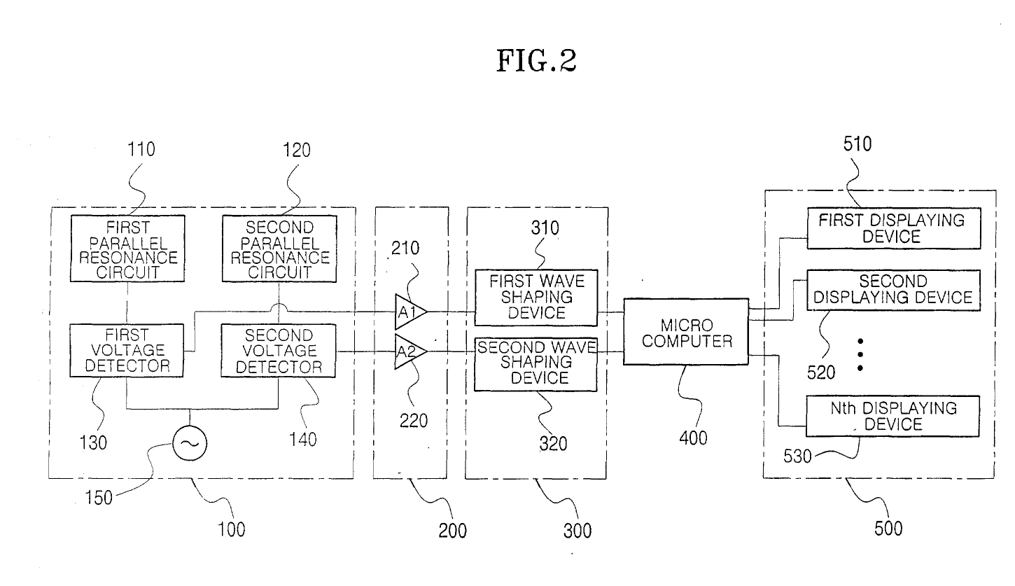

FIG. 1 and FIG. 2 are respectively a rough block diagram and a detailed block diagram of a device for measuring swing velocity of a golf club head using the resonance circuit according to the present invention.

According to FIG. 1, the device for measuring swing velocity of a golf club head using a resonance circuit comprises a resonance circuit portion 100, an amplification portion 200, a wave shaping portion 300, a microcomputer 400, and a displaying portion 500. The resonance circuit portion 100 comprises a first parallel resonance circuit 110, a second parallel resonance circuit 120, a first voltage detector 130, a second voltage detector 140, and an oscillator 150 as shown in FIG. 2. The resonance circuit portion 100 detects the amount of impedance change generated from each resonance circuit and voltage signal based on the amount of impedance change, as a golf club head having conductivity becomes closer to the first and second parallel resonance circuit, and then input the detected voltage signal into the amplification portion 200.

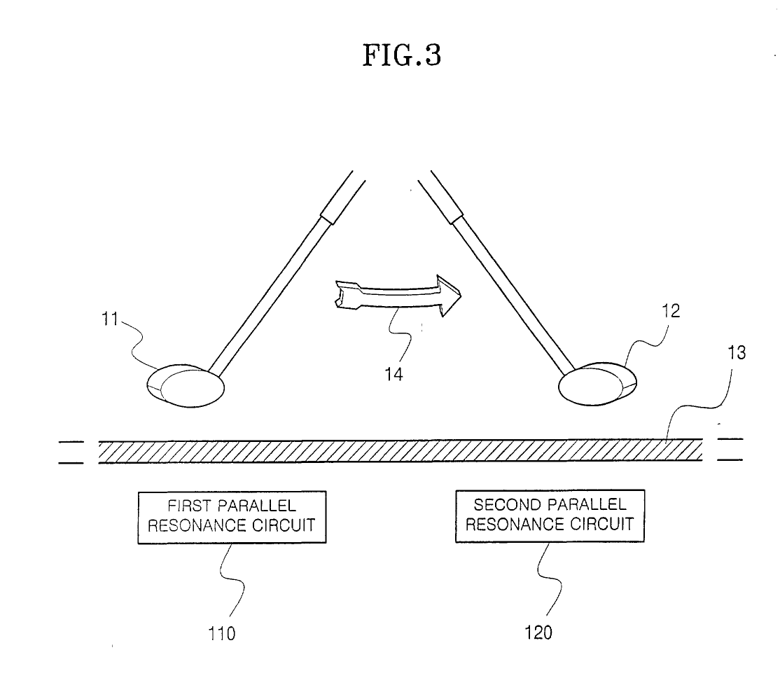

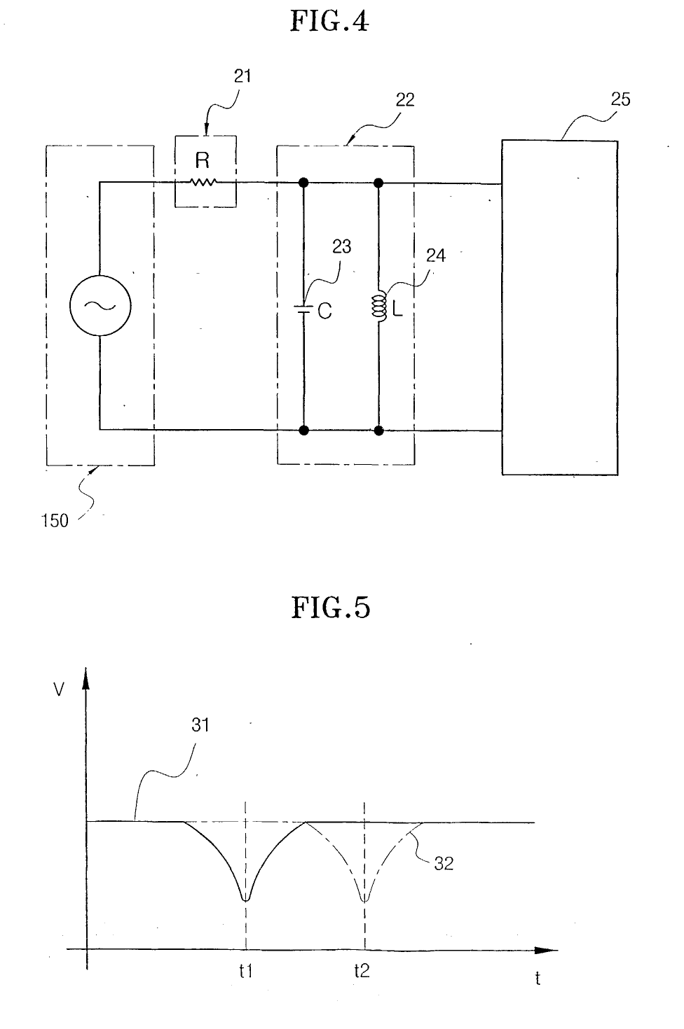

FIG. 3 shows that a golf club head is being swung with using the device for measuring swing velocity of a golf club head according to the present invention, and FIG. 4 is a circuit diagram for showing operation process of the parallel resonance circuit when a golf club head is swung with using the device for measuring swing velocity of a golf club head according to the present invention.

According to FIG. 3, the first parallel resonance circuit 110 and the second parallel resonance circuit 120 forming the resonance circuit portion 100 are mounted spaced by a predetermined distance from a lower portion of a bottom portion, which is the ground or the mat. The first parallel resonance circuit 110 senses the impedance change according to a first swing 11 of a golf club head swung by a user in an indicated direction 14 and inputs the same into the first voltage detector 130, and the second parallel resonance circuit 120 senses the impedance change according to a second swing 12 of the golf club head and inputs the same into the second voltage detector 140.

According to FIG. 4, it is preferable that the first and second parallel resonance circuits 110 and 120 comprises an oscillator 150, resistance 21, an inductive reactance K_{L}, i.e. inductance L:24, and a capacitive reactance X_{C}, i.e. capacitance C:23. When the golf club head is swung, the impedance changes occur from the first and second parallel resonance circuits 110 and 120 in serial with a time difference, and the impedance changes induce voltage changes. Each voltage change generated from the first and second parallel resonance circuits 110 and 120 is detected by the first voltage detector 130 and the second voltage detector 140.

The concrete operation processes of the first and second parallel resonance circuits 110 and 120 according to the golf club swing are as follows: the circuits are maintained in resonance state such that the impedance is maximum in the condition of X_{L}=X_{C} before the golf club is swung; when the user swing the golf club, the inductive reactance X_{L} is changed according to an electromagnetic principle to change the impedances of the first and second parallel resonance circuits 110 and 120; and each voltage signal according to the impedance change is detected by the first and second voltage detectors 130 and 140.

FIG. 5 is a diagram of voltage waveform showing-voltage changes detected by the first voltage detector 130 and the second voltage detector 140 in response to time.

According to FIG. 5, first voltage signal 31 detected by the first voltage detector 130 reaches the peak value at the moment of t₁ when the first swing 11 is made, and second voltage signal 32 detected by the second voltage detector 140 reaches the peak value at the moment of t₂ when the second swing 12 is made. From such wave changes of the first and second voltage signals 31 and 32, the time values at the moments of t₁ and t₂ may respectively be supposed the time values at the moments that the golf club head approaches to the first and second parallel resonance circuits 110 and 120.

The first voltage signal 31 and the second voltage signal 32 respectively detected by the first voltage detector 130 and the second voltage detector 140 are input into the amplification portion 200. The amplification portion 200 comprises a first amplifier A1:210 and a second amplifier A2:220 as shown in FIG. 2. The first amplifier A1:210 amplifies the first voltage signal 31 and inputs the same into a first wave shaping device 310, and the second amplifier A2:220 amplifies the second voltage signal 32 and inputs the same into a second wave shaping device 320.

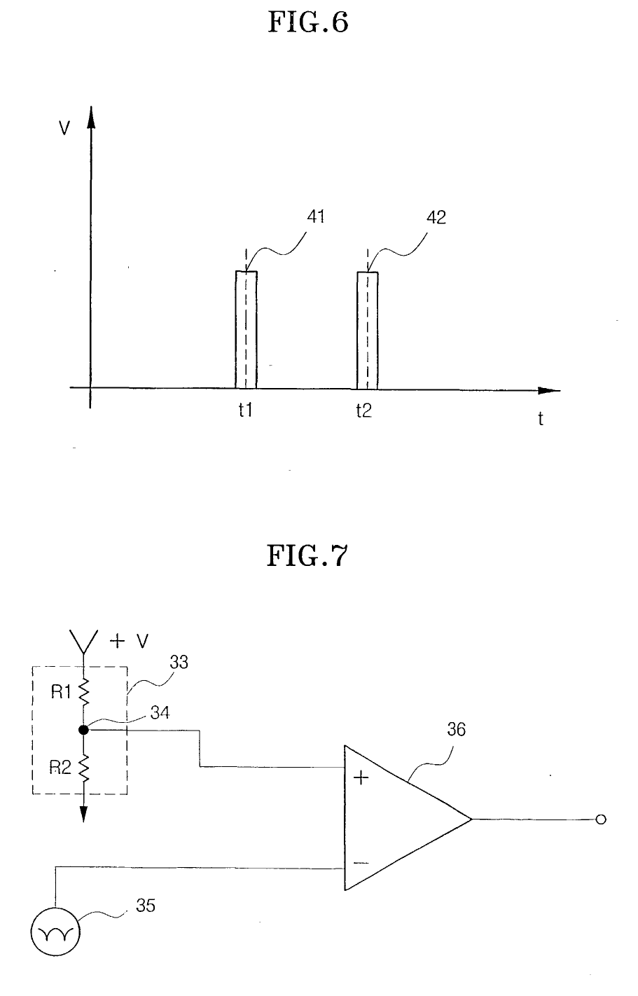

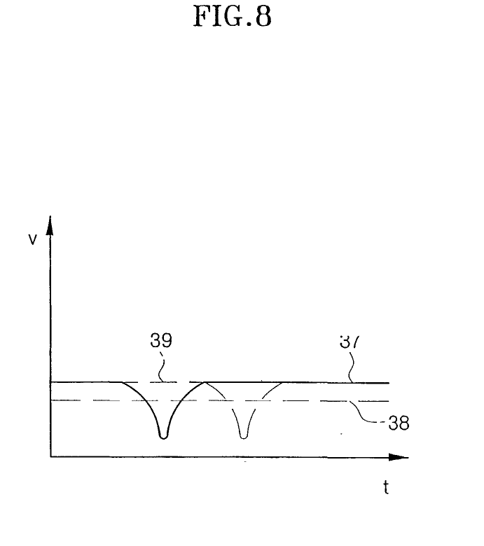

FIG. 6 is a diagram of voltage waveform showing voltage changes output from the wave shaping portion 300 in response to time, FIG. 7 is a circuit diagram of an embodiment of the first and second wave shaping devices 310 and 320, and FIG. 8 is a diagram of voltage waveform showing a principle that the voltage signal is shaped in a wave shaping portion 300 comprising a first and a second wave shaping devices 310 and 320, which are included in a device for measuring swing velocity of a golf club head according to the present invention, by showing both comparative voltage value for shaping voltage and amplified voltage signal input from the amplification portion 200.

The wave shaping portion 300 according to the present invention comprises the first wave shaping device 310 and the second wave shaping device 320 as shown in FIG. 2. The first wave shaping device 310 and the second wave shaping device 320, as shown in FIG. 6, shapes the first voltage signal 31 and the second voltage signal 32 amplified in the amplification portion 200 as a first peak wave 41 and a second peak wave 42, which are pulse-shaped peak waves, and inputs the same into a microcomputer 400. The first and second wave shaping devices 310 and 320, each comprises a voltage divider 33 formed of two resistances R1 and R2 and an amplifier 36.

The amplified voltage signals 37 and 39 as shown in FIG. 8 are input in serial with time difference into a negative input terminal of the amplifier 36 comprised in the first and second wave shaping devices 310 and 320 each, and the divided voltage applied to a node 34 between the two resistance R1 and R2 is input, as comparative voltage value 38, into a positive input terminal of the amplifier 36 comprised in the first and second wave shaping devices 310 and 320 each. Since the voltage signals 37 and 39 amplified in the amplification portion 200 have wave portion lower than the comparative voltage value 38, the wave shaping portion 300 generates the pulse-shaped peak waves 41 and 42 as shown in FIG. 6 with time difference.

The microcomputer 400 of the inventive device for measuring swing velocity of a golf club head calculates the swing velocity of a golf club by using the time difference t₂−t₁ of the first peak wave 41 and the second peak wave 42 and the distance between the first parallel resonance circuit 110 and the second parallel resonance circuit 120, and outputs the calculated data to a display portion 500.

The velocity of a golf club can be calculated according to the following mathematical formula 1.

Mathematical formula 1]

$$\frac{S}{{t}_{2} - {t}_{1}}$$

In addition, when the user swings the golf club head plural times, the microcomputer 400 stores in the memory the generation times of the first peak wave 41 and the second peak wave 42 successively, which are input from the wave shaping portion 300 whenever the golf club head is swung, and outputs calculated data such as average value, dispersion rate, deviation and standard deviation of swing velocity of the golf club head to the display portion 500 when required by the user. For this, the inventive device for measuring swing velocity of a golf club head may comprise a control panel for requesting the microcomputer 400 to calculate the average value, the dispersion, the deviation and the standard deviation of swing velocity of the golf club head, and the microcomputer 400 may be loaded with a program for processing the data related to the swing velocity of the golf club head in response to a requesting signal input from the control panel. Although the control panel and the program for processing the data are not concretely represented in the detailed description of embodiments and accompanied drawings thereto, those are natural for a person who has standard knowledge in this technical area.

If necessary, the display portion 500 comprises a multiplicity of display devices using LED 7 segment as shown in FIG. 2 each for displaying each swing velocity of the golf club head calculated every time when the golf club head is swung. In this case, the display portion 500 can be formed to be functioned as follows: when the user swings 1˜N times, the Nth swing velocity data is displayed in the first displaying device 510 and the swing velocity data from the (N−1)th to the first swing are respectively displayed in the second displaying device 520 to the Nth one in reverse order.

In addition, if necessary, the microcomputer 400 according to the present invention may calculate the flight distance of a golf ball on the basis of the swing velocity of the golf club head, and display the same through the display portion 500 with the swing velocity of the golf club head. The flight distance can be calculated according to the following mathematical formula 2.

Mathematical formula 2]

flight distance of golf ball=swing velocity of golf club head(m/sec)×0.5˜5.5)(yard)

Here, the numerals multiplied by the swing velocity of the golf club head are the statistically known ones to a person who has standard knowledge in this technical area. The microcomputer 400 may be controlled to multiply a fixed numeral by every swing velocity of the golf club head (in this case, an error may be made in the flight distance of golf ball), and may be controlled to multiply a different numeral according to the swing velocity of the golf club head for accurate calculation of the flight distance (in this case, it is preferable to store the statistical data of the flight distance according to the swing velocity of the golf club head in the memory of the microcomputer 400).

In the case of the flight distance of a golf ball being displayed with the swing velocity of a golf club head, the inventive device may further comprise a separate displaying device for displaying the calculated flight distance of the golf ball as a graphic interface. Since the displaying device for displaying the flight distance of the golf ball can be embodied referring to the art for the displaying device for displaying the swing velocity of the golf club head, so that the detailed description on the same is omitted.

The most preferable embodiments are described above. Although specific terms are used for the description of the present invention, it is just for describing the present invention, but not for restricting meanings or the scope of the present invention described in claims. For example, the resonance circuit portion may be embodied as a proximity sensor in which the parallel resonance circuit and the voltage detector are packaged as a constituent thereof.

The device for measuring swing velocity of a golf club head according to the present invention has advantages that the device allows the user to swing at regular and stable maximum speed by displaying the swing velocity of the golf club head so that the user can monitor the same at the impact moment of a golf ball, and provides the user more detailed information by displaying the current velocity data compared with the former swing velocity data on a multiplicity of displaying devices.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A device for measuring swing velocity of a golf club head, comprising a resonance circuit portion having a first parallel resonance circuit and a second parallel resonance circuit that are spaced from each other by a predetermined distance, a first voltage detector and a second voltage detector for detecting voltage signal by the amount of impedance change generated from each resonance circuit as a golf club head having conductivity becomes closer to said first and second parallel resonance circuits, and an oscillator applying predetermined frequency to said first and second parallel resonance circuits;
an amplification portion for amplifying each voltage signal detected by said first and second voltage detectors;
a wave shaping portion for outputting each voltage signal output from said amplification portion as pulse-shaped peak wave on the basis of predetermined comparative voltage value;
a microcomputer for controlling the operation of calculating a time difference between the peak waves, and indicating swing velocity data of the golf club head using the time difference and the distance between said first parallel resonance circuit and said second parallel resonance circuit; and
a display portion for displaying the swing velocity data according to the output signal of said microcomputer.

2. The method according to claim 1, wherein said display portion comprises a multiplicity of displaying devices functioning as follows: when the golfer swings 1˜N times, the Nth swing data is displayed in the first displaying device and the data from the (N−1)th to the first swing are respectively displayed in the second displaying device to the Nth one in reverse order.

3. The device according to claim 2, wherein said displaying device displays the average of swing data, the dispersion rate, the deviation, and the standard deviation according to the control of the microcomputer.

4. The device according to claim 1 further comprises a displaying device or displaying a flight distance of a golf ball on the basis of the swing velocity of the golf club head according the control of said microcomputer.
